(19) United States
(12) Patent Application Publication
(10) Pub. No.: US 2014/0017495 A1
(43) Pub. Date: Jan. 16, 2014

(54) Biodegradable Aliphatic Polyester Particles and Production Process Thereof

(71) Applicants: Masahiro Yamazaki, Tokyo (JP); Kotaku Saigusa, Tokyo (JP); Shunsuke Abe, Tokyo (JP); Nanako Saigusa, Tokyo (JP); Hiroyuki Sato, Tokyo (JP)

(72) Inventors: Masahiro Yamazaki, Tokyo (JP); Kotaku Saigusa, Tokyo (JP); Shunsuke Abe, Tokyo (JP); Nanako Saigusa, Tokyo (JP); Hiroyuki Sato, Tokyo (JP)

(73) Assignee: KUREHA CORPORATION, Tokyo (JP)

(21) Appl. No.: 14/006,982

(22) PCT Filed: Mar. 21, 2012
(86) PCT No.: PCT/JP2012/057165

§ 371 Date: Sep. 24, 2013

(30) Foreign Application Priority Data
Mar. 25, 2011 (JP) 2011-068235

(51) Int. Cl. C08G 63/88; C08G 63/06

(52) U.S. Cl. CPC C08G 63/88; C08G 63/06
USPC 428/402; 528/361

(57) ABSTRACT

The invention provides biodegradable aliphatic polyester particles having the following physical properties: (A) the average particle diameter thereof is 5 to 500 μm; and (B) the fracture stress of a columnar tablet obtained by molding the particles in a cylindrical mold by applying a load of 4 kgf/cm² for 1 hour at a temperature of 40° C. is at most 500 gf/cm², and preferably also having the following property: (C) the fracture stress of a columnar tablet obtained by molding the particles in a cylindrical mold by applying a load of 4 kgf/cm² for 1 hour at a temperature of [the glass transition temperature (Tg) of a biodegradable aliphatic polyester +10° C.] is at most 2,000 gf/cm², a process for producing the biodegradable aliphatic polyester particles, which comprises treating a particulate biodegradable aliphatic polyester obtained by grinding at a temperature lower than the Tg at a temperature not lower than [the crystallization temperature (T_{c1}) upon heating of the biodegradable aliphatic polyester−40° C], and the biodegradable aliphatic polyester particles obtained by the production process.

### TECHNICAL FIELD

The present invention relates to biodegradable aliphatic polyester particles high in a blocking preventing effect and a production process thereof.

### BACKGROUND ART

Since aliphatic polyesters such as polyglycolic acid and polylactic acid are degraded by microorganisms or enzymes present in the natural world such as soil and sea, they attract attention as biodegradable polymeric materials which impose little burden on the environment. These biodegradable aliphatic polyesters are also utilized as medical polymeric materials for surgical sutures, artificial skins, etc. because they have degradability and absorbability in vivo.

As the biodegradable aliphatic polyesters, are known polylactic acid (hereinafter may referred to as “PLA”) composed of a repeating unit of lactic acid, polyglycolic acid (hereinafter may referred to as “PGA”) composed of a repeating unit of glycolic acid, lactone-based polyesters such as poly-E-caprolactone, polyhydroxybutyrate-based polyesters and copolymers thereof, for example, copolymers composed of a repeating unit of glycolic acid and a repeating unit of lactic acid.

Among the biodegradable aliphatic polyesters, PLA has such features that L-lactic acid which becomes a raw material is cheaply obtained from corn, root vegetables and the like by a fermentation process, the total amount of carbon dioxide emissions is small because it is derived from natural agricultural products, and it is strong in rigidity and good in transparency as the performance of the resultant poly-L-lactic acid (hereinafter may referred to as “PLLA”). However, PLA such as PLLA is slow in crystallization speed, and so such a problem as it needs to conduct a mechanical step such as stretching is indicated.

On the other hand, PGA among the biodegradable aliphatic polyesters is excellent in heat resistance and mechanical strength such as tensile strength and also excellent in gas barrier properties when formed into a film or sheet in particular in addition to high degradability. Therefore, PGA is expected to be used as agricultural materials, various packaging (container) materials and medical polymeric materials, and so its new uses are developed either singly or in the form of a composite with other resin materials or the like.

As methods for producing a product from a biodegradable aliphatic polyester, are adopted melt forming or molding methods and other methods such as extrusion, injection molding, compression molding, injection compression molding, transfer molding, cast molding, stampable molding, blow molding, stretch film forming, inflation film forming, laminate molding, calendering, foam extrusion, RIM, FRP molding, powder molding and paste molding. Pellets of a biodegradable aliphatic polyester such as PGA, which are used as a raw material for the melt forming or molding, are those obtained by melt-extruding the biodegradable aliphatic polyester such as PGA into a strand by means of, for example, a twin-screw extruder and cutting the strand into a desired size and having an average particle diameter of about several millimeters.

On the other hand, attention is attracted to the degradability, strength, etc. of the biodegradable aliphatic polyester such as PLA or PGA, and it is desirable to provide biodegradable aliphatic polyester particles useful as a raw material, an additive or the like in fields of paints, coating materials, inks, toners, agricultural chemicals, medicines, cosmetics, mining, boring, etc. The biodegradable aliphatic polyester particles applied to these fields have a particle diameter smaller than the above-described biodegradable aliphatic polyester pellets, and relatively small particles having a particle diameter and a particle diameter distribution conforming to the end application thereof are required. In addition, the biodegradable aliphatic polyester particles are required to have excellent handleability and storage stability.

In addition, the biodegradable aliphatic polyester which becomes a raw resin for producing pellets of the biodegradable aliphatic polyester by melt extrusion is used in the form that a biodegradable aliphatic polyester in the form of, for example, flake, which has been collected after a polymerization reaction, has been formed into particles having desired shape and size.

Particles having a small particle diameter become poor in handleability, high in hygroscopicity and large in surface area, and so the influence of degradation speed becomes great, there is a possibility that the excellent properties of the biodegradable aliphatic polyester may be lowered, and there is also a slight possibility that unexpected troubles may occur in a drying step or molding and processing.

Production processes of resin particles of a biodegradable aliphatic polyester such as PLA or PGA have been variously proposed.

As the production processes of the biodegradable aliphatic polyester particles, are generally known a production process of particles by cutting or grinding of a melted and solidified product and a production process of particles by deposition from a solution or dispersion liquid. Japanese Patent Application Laid-Open No. 2001-288273 (Patent Literature 1) discloses a production process of polylactic acid-based resin powder, in which chips or a massive product composed of a PLA resin is refrigerated to a low temperature of −50 to −180° C., impact-ground and classified. Japanese Patent Application Laid-Open No. 11-35693 (Patent Literature 2) discloses a production process of a particulate biodegradable polyester, in which an organic solvent solution of a biodegradable aliphatic polyester is mixed with an aromatic hydrocarbon at a temperature lower than 60° C., and solids deposited are subjected to solid-liquid separation. In Examples thereof, PLA having an Mw of 145,000, polybutylene succinate having an Mw of 100,000, and copolymer of PLA and polybutylene succinate having an Mw of 172,000 are respectively used as raw materials. Japanese Patent Application Laid-Open No. 2006-45542 (Patent Literature 3) discloses PLA particles obtained by using PLA and a solvent (a mixture of dimethyl adipate, dimethyl glutarate and dimethyl succinate, DBE (trademark), product of Du Pont Kabushiki Kaisha) and controlling a dissolution temperature and a refrigeration temperature to 140° C. and −35° C., respectively, and having an average primary particle diameter of 250 nm or less as Preparation Example 3, and PGA particles obtained by using PGA and a solvent (bis(2-methoxyethyl)ether) and controlling a dissolution temperature and a refrigeration temperature to 150° C. and −35° C., respectively, and having an average primary particle diameter of 150 nm or less as Preparation Example 4.

However, even when particles of a biodegradable aliphatic polyester such as PLA or PGA are provided as particles having an average particle diameter, particle diameter distribution and shape suitable for use, such biodegradable aliphatic polyester particles may have aggregated (undergone blocking) in some cases while they have been stored or shipped in the state of particles until the particles are thereafter used in a product of such use as described above. In particular, when a load is applied to the biodegradable aliphatic polyester particles under a temperature environment of a temperature near the glass transition temperature of the resin or higher, the blocking is liable to occur. Since the particles may be exposed to a temperature of 40° C. or higher in, for example, summertime or upon storage or shipping of the particles in a container, there has been a demand for developing measures to prevent the blocking. When the blocking occurs, the handleability of the particles is deteriorated, and moreover the controlled average particle diameter, particle diameter distribution and shape of the particles may be lost in some cases to fail to develop the expected properties thereof.

Therefore, although measures that a storing method is changed (low-temperature storage, flat stacking, etc.) have been taken, the change of the storing method involves a problem leading to increase in production cost, and so there has been a demand for development of a better improvement.

### CITATION LIST

### Patent Literature

Patent Literature 1: Japanese Patent Application Laid-Open No. 2001-288273

Patent Literature 2: Japanese Patent Application Laid-Open No. 11-35693

Patent Literature 3: Japanese Patent Application Laid-Open No. 2006-45542

### SUMMARY OF INVENTION

### Technical Problem

It is an object of the present invention to provide biodegradable aliphatic polyester particles high in a blocking preventing effect and a production process thereof.

### Solution To Problem

In order to achieve the above object, the present inventors have extensively continued analysis of a phenomenon that the blocking of biodegradable aliphatic polyester particles occurs and found that the surfaces of biodegradable aliphatic polyester particles obtained by what is called an impact-grinding method in particular are melted and softened by shearing force upon the grinding, and a proportion of a non-crystallized portion becomes great. As a result of a further investigation, it has been found that the above object can be achieved by preventing the surfaces of the biodegradable aliphatic polyester particles from melting and softening to control the surface profile thereof, thus leading to completion of the present invention.

According to the present invention, there are thus provided biodegradable aliphatic polyester particles having the following physical properties (A) and (B): (A) the average particle diameter thereof is 5 to 500 μm; and (B) the fracture stress of a columnar tablet obtained by molding the particles in a cylindrical mold by applying a load of 4 kgf/cm² for 1 hour at a temperature of 40° C. is at most 500 gf/cm².

According to the present invention, there are also provided biodegradable aliphatic polyester particles respectively characterized by the following (1) to (4) as embodiments.

(1) The biodegradable aliphatic polyester particles which further have the following physical property (C):

(C) the fracture stress of a columnar tablet obtained by molding the particles in a cylindrical mold by applying a load of 4 kgf/cm² for 1 hour at a temperature of (the glass transition temperature of a biodegradable aliphatic polyester contained in the biodegradable aliphatic polyester particles+10° C.) is at most 2,000 gf/cm².

(2) The biodegradable aliphatic polyester particles, wherein the biodegradable aliphatic polyester is PGA, PLA or a mixture thereof.

(3) The biodegradable aliphatic polyester particles which are obtained by treating a particulate biodegradable aliphatic polyester at a temperature not lower than (the crystallization temperature upon heating of the biodegradable aliphatic polyester−40° C.).

(4) The biodegradable aliphatic polyester particles, wherein the particulate biodegradable aliphatic polyester is obtained by grinding at a temperature lower than the glass transition temperature of the biodegradable aliphatic polyester.

According to the present invention, there are further provided a process for producing the biodegradable aliphatic polyester particles, which comprises treating a particulate biodegradable aliphatic polyester at a temperature not lower than (the crystallization temperature upon heating of the biodegradable aliphatic polyester−40° C.), and particularly, a process for producing the biodegradable aliphatic polyester particles, wherein the particulate biodegradable aliphatic polyester is obtained by grinding at a temperature lower than the glass transition temperature of the biodegradable aliphatic polyester.

### Advantageous Effects of Invention

The present invention exhibits an effect that the biodegradable aliphatic polyester particles have the following physical properties: (A) the average particle diameter (50% D) thereof is 5 to 500 μm, and (B) the fracture stress of a columnar tablet obtained by molding the particles in a cylindrical mold by applying a load of 4 kgf/cm² for 1 hour at a temperature of 40° C. is at most 500 gf/cm², whereby particles of a biodegradable aliphatic polyester such as PLA or PGA, which are hard to cause blocking even upon storage or shipping thereof, are provided. [0025]

The present invention also exhibits an effect that the process for producing the biodegradable aliphatic polyester particles is a process comprising treating a particulate biodegradable aliphatic polyester at a temperature not lower than (the crystallization temperature upon heating of the biodegradable aliphatic polyester−40° C.), whereby particles of a biodegradable aliphatic polyester such as PLA or PGA, which are hard to cause blocking even upon storage or shipping thereof, can be simply provided.

### DESCRIPTION OF EMBODIMENTS

1. Biodegradable aliphatic polyester

Examples of a biodegradable aliphatic polyester forming the biodegradable aliphatic polyester particles according to the present invention include homopolymers and copolymers of aliphatic ester monomers, such as cyclic monomers such as glycolic acids including glycolic acid and glycolide (GL) that is a bimolecular cyclic ester of glycolic acid, lactic acids including lactic acid and lactide that is a bimolecular cyclic ester of lactic acid, ethylene oxalate (i.e., 1,4-dioxane-2,3-dione), lactones (for example, β-propiolactone, β-butyrolactone, pivalolactone, γ-butyrolactone, δ-valerolactone, β-methyl-δ-valerolactone and ε-caprolactone), carbonates (for example, trimethylene carbonate), ethers (for example, 1,3-dioxane), and ether esters (for example, dioxanone); hydroxycarboxylic acid such as 3-hydroxypropanoic acid, 4-hydroxybutanoic acid and δ-hydroxycaproic acid, and alkyl esters thereof; and substantially equimolar mixtures of an aliphatic diol such as ethylene glycol or 1,4-butanediol and an aliphatic carboxylic acid such as succinic acid or adipic acid or an alkyl ester thereof. Among these, biodegradable aliphatic polyesters having at least 70% by mol of a glycolic acid or lactic acid repeating unit represented by a formula: [—O—CH(R)—C(O)—] (R is a hydrogen atom or a methyl group) are preferred. Specifically, PLAs such as PLLA, i.e., a homopolymer of L-lactic acid, a homopolymer of D-lactic acid, copolymers having at least 70% by mol of an L-lactic acid or D-lactic acid repeating unit and mixtures thereof, PGA, i.e., a homopolymer of glycolic acid and copolymers having at least 70% by mol of a glycolic acid repeating unit, and mixtures of PLA and PGA are preferred. PGA or PLA is particularly preferred from the viewpoints of degradability, heat resistance and mechanical strength.

These biodegradable aliphatic polyesters can be synthesized by, for example, dehydration polycondensation of a α-hydroxycarboxylic acid such as glycolic acid or lactic acid, which is publicly known. In addition, a process in which a bimolecular cyclic ester of an α-hydroxycarboxylic acid is synthesized, and the cyclic ester is subjected to ring-opening polymerization is adopted for efficiently synthesizing a high-molecular weight biodegradable aliphatic polyester. For example, when lactide that is a bimolecular cyclic ester of lactic acid is subjected to ring-opening polymerization, PLA is obtained. When glycolide that is a bimolecular cyclic ester of glycolic acid is subjected to ring-opening polymerization, PGA is obtained.

PLA can be synthesized by the above-described process, and, for example, “LACEA SERIES” such as LACEA: H-100, H-280, H-400 and H-440 (products of Mitsui Chemicals, Inc.), “INGEO”: 3001D, 3051D, 4032D, 4042D, 6201D, 6251D, 7000D and 7032D (products of Nature Works LLC), and “ECO PLASTIC U'z SERIES” such as ECO PLASTIC U'z: S-09, S-12 and S-17 (products of Toyota Motor Corporation) are preferably selected as commercially available products from the viewpoints of reconciliation of strength and flexibility, and heat resistance.

The biodegradable aliphatic polyester will hereinafter be described in more detail taking PGA as an example. Even in PLA and other biodegradable aliphatic polyesters, however, the mode for carrying out the invention may be taken conforming to the PGA.

### [Polyglycolic Acid (PGA)]

PGA particularly preferably used as a raw material for the biodegradable aliphatic polyester particles according to the present invention includes not only a glycolic acid homopolymer [including a ring-opening polymer of glycolide (GL) that is a bimolecular cyclic ester of glycolic acid] composed of only a repeating unit represented by the formula: [—O—CH₂—C(O)—] but also PGA copolymers containing the above repeating unit at a proportion of at least 70% by mass.

As examples of a comonomer for providing a PGA copolymer together with a glycolic acid monomer such as the glycolide, may be mentioned cyclic monomers such as ethylene oxalate (i.e., 1,4-dioxane-2,3-dione), lactides, lactones, carbonates, ethers, ether esters and amides; hydroxycarboxylic acids such as lactic acid, 3-hydroxypropanoic acid, 3-hydroxybutanoic acid, 4-hydroxybutanoic acid and δ-hydroxycaproic acid, and alkyl ester thereof; substantially equimolar mixtures of an aliphatic diol such as ethylene glycol or 1,4-butanediol and an aliphatic dicarboxylic acid such as succinic acid or adipic acid or an alkyl ester thereof; and mixtures of two or more monomers thereof. These comonomers may also be used in the form of polymers thereof as starting materials for providing the PGA copolymer together with the glycolic acid monomer such as the glycolide.

The proportion of the glycolic acid repeating unit in the PGA which becomes a raw material of the PGA particles according to the present invention is at least 70% by mass, preferably at least 80% by mass, more preferably at least 90% by mass, still more preferably at least 95% by mass, particularly preferably at least 98% by mass, most preferably at least 99% by mass providing PGA that is substantially a homopolymer. If the proportion of the glycolic acid repeating unit is too low, the strength and degradability expected of PGA become poor. Other repeating units than the glycolic acid repeating unit are used in a proportion of at most 30% by mass, preferably at most 20% by mass, more preferably at most 10% by mass, still more preferably at most 5% by mass, particularly preferably at most 2% by mass, most preferably at most 1% by mass and may not be contained.

As the PGA which becomes a raw material of the PGA particles according to the present invention, is preferred PGA obtained by polymerizing 70 to 100% by mass of glycolide and 30 to 0% by mass of the other comonomers described above for efficiently producing a desired high-molecular weight polymer. The other comonomer may be either a bimolecular cyclic monomer or a mixture of both monomers, not the cyclic monomer. However, the cyclic monomer is preferred for providing the PGA particles intended by the present invention. PGA obtained by subjecting 70 to 100% by mass of glycolide and 30 to 0% by mass of another cyclic monomer to ring-opening polymerization will hereinafter be described in detail.

### [Glycolide]

Glycolide for forming PGA by ring-opening polymerization is a bimolecular cyclic ester of glycolic acid that is a hydroxycarboxylic acid. No particular limitation is imposed on the production process of the glycolide. However, the glycolide can be generally obtained by depolymerizing a glycolic acid oligomer under heat. As a method for the depolymerization of the glycolic acid oligomer, may be adopted, for example, a melt depolymerization method, a solid-phase depolymerization method or a solution-phase depolymerization method. Glycolide obtained as a cyclic condensate of a chloroacetic acid salt may also be used. Incidentally, that containing glycolic acid in an amount up to 20% by mass of the glycolide may be used as the glycolide if desired.

The PGA which becomes a raw material of the PGA particles according to the present invention may be formed by subjecting the glycolide alone to ring-opening polymerization. However, a copolymer may also be formed by subjecting another cyclic monomer as a copolymerization component to the ring-opening polymerization together with the glycolide. When the copolymer is formed, the proportion of the glycolide is at least 70% by mass, preferably at least 80% by mass, more preferably at least 90% by mass, still more preferably at least 95% by mass, particularly preferably at least 98% by mass, most preferably at least 99% by mass providing PGA that is substantially a homopolymer.

### [Another Cyclic Monomer]

As another cyclic monomer usable as a copolymerization component together with the glycolide, a cyclic monomer such as a lactone (for example, β-propiolactone, β-butyrolactone, pivalolactone, γ-butyrolactone, δ-valerolactone, β-methyl-δ-valerolactone or ε-caprolactone), trimethylene carbonate or 1,3-dioxane may be used in addition to a bimolecular cyclic ester of another hydroxycarboxylic acid, such as lactide. Preferable another cyclic monomer is a bimolecular cyclic ester of another hydroxycarboxylic acid, and as examples of the hydroxycarboxylic acid, may be mentioned L-lactic acid, D-lactic acid, α-hydroxybutyric acid, α-hydroxyisobutyric acid, α-hydroxyvaleric acid, α-hydroxγ-caproic acid, α-hydroxyisocaproic acid, α-hydroxyheptanoic acid, α-hydroxyoctanoic acid, α-hydroxydecanoic acid, α-hydroxymyristic acid, α-hydroxystearic acid and alkyl-substituted products thereof. A particularly preferable another cyclic monomer is lactide that is a bimolecular cyclic ester of lactic acid, and the lactide may be any of an L-form, a D-form, a racemic modification and mixtures thereof.

Another cyclic monomer is used in a proportion of at most 30% by mass, preferably at most 20% by mass, more preferably at most 10% by mass, still more preferably at most 5% by mass, particularly preferably at most 2% by mass, most preferably at most 1% by mass. The glycolide and another cyclic monomer are subjected to ring-opening polymerization, whereby the melting point of the resulting PGA (copolymer) can be lowered to lower the processing temperature thereof, and the crystallization speed of the PGA can be controlled to improve the extrusion processability and stretch processability thereof. However, if the proportion of these cyclic monomers used is too high, the crystallinity of PGA (copolymer) formed is impaired, and its heat resistance, gas barrier properties, mechanical strength, etc. are deteriorated. Incidentally, when the PGA is formed from 100% by mass of glycolide, the proportion of another cyclic monomer is 0% by mass, and this PGA is also included in the scope of the present invention.

### [Ring-Opening Polymerization Reaction]

The ring-opening polymerization or ring-opening copolymerization (hereinafter may be referred to as “ring-opening (co)polymerization” generally) of glycolide is preferably conducted in the presence of a small amount of a catalyst. No particular limitation is imposed on the catalyst. However, examples thereof include tin compounds such as tin halides (for example, tin dichloride, tin tetrachloride, etc.) and organic tin carboxylates (for example, tin octanoates such as tin 2-ethylhexanoate); titanium compounds such as alkoxytitanates; aluminum compounds such as alkoxyaluminum; zirconium compounds such as zirconium acetylacetone; and antimony compounds such as antimony halides and antimony oxide. The amount of the catalyst used is preferably about 1 to 1,000 ppm, more preferably about 3 to 300 ppm in terms of a mass ratio to the cyclic ester.

In the ring-opening (co)polymerization of glycolide, a protic compound such as a higher alcohol such as lauryl alcohol, another alcohol or water may be used as a molecular weight modifier for the purpose of controlling the physical properties of a PGA formed, such as melt viscosity and molecular weight. Glycolide may generally contain a trace amount of water and hydroxycarboxylic acid compounds composed of glycolic acid and linear glycolic acid oligomers as impurities in some cases, and these compounds also act on a polymerization reaction. Therefore, the concentration of these impurities, for example, the amount of the carboxylic acids in the these compounds is determined as a molar concentration by neutralization titration or the like, and an alcohol and/or water is added as a protic compound according to the intended molecular weight to control the molar concentration of the whole protic compound to the glycolide, whereby the molecular weight and the like of the PGA formed can be controlled. In addition, a polyhydric alcohol such as glycerol may also be added for the purpose of improving the physical properties of the resulting PGA.

The ring-opening (co)polymerization of the glycolide may be conducted by either bulk polymerization or solution polymerization. In many cases, however, the bulk polymerization is adopted. A polymerizer for the bulk polymerization may be suitably selected from among various kinds of apparatus such as extruder type, vertical type having a paddle blade, vertical type having a helical ribbon blade, horizontal type such as an extruder type or kneader type, ampoule type, plate type and annular type. Various kinds of reaction vessels may be used for the solution polymerization.

The polymerization temperature can be suitably preset within a range of from 120° C., which is a substantial polymerization-initiating temperature, to 300° C. as necessary for the end application intended. The polymerization temperature is preferably 130 to 270° C., more preferably 140 to 260° C., particularly preferably 150 to 250° C. If the polymerization temperature is too low, PGA formed tends to have a wide molecular weight distribution. If the polymerization temperature is too high, PGA formed tends to undergo thermal decomposition. The polymerization time is within a range of from 3 minutes to 50 hours, preferably from 5 minutes to 30 hours. If the polymerization time is too short, it is hard to sufficiently advance the polymerization, and so a desired weight average molecular weight cannot be realized. If the polymerization time is too long, PGA formed tends to be colored.

After the PGA formed is solidified, the PGA may be further subjected to solid-phase polymerization if desired. The solid-phase polymerization means an operation that the PGA is heated at a temperature lower than the melting point (Tm) of the PGA, thereby subjecting the PGA to a heat treatment while retaining the solid state. A low-molecular weight component such as an unreacted monomer or an oligomer is evaporated and removed by this solid-phase polymerization. The solid-phase polymerization is conducted for preferably 1 to 100 hours, more preferably 2 to 50 hours, particularly preferably 3 to 30 hours.

Thermal history may be applied to the PGA in the solid state by a step of melting and kneading the PGA at a temperature higher by at least 38° C. than the crystalline melting point (Tm) of the PGA, preferably in a temperature range of from (the crystalline melting point (Tm)+38° C.) to (the crystalline melting point (Tm)+100° C.), thereby controlling the crystallinity thereof.

### 2. Biodegradable Aliphatic Polyester Particles

The biodegradable aliphatic polyester particles according to the present invention are particles comprising a biodegradable aliphatic polyester as a main component and are preferably PGA particles, PLA particles or mixed particles of PGA particles and PLA particles, particularly preferably PGA particles. The biodegradable aliphatic polyester particles will hereinafter be described in more detail taking PGA particles as an example. Even in PLA particles and particles of any other biodegradable aliphatic polyester, however, the mode for carrying out the invention may be taken conforming to the PGA particles.

The biodegradable aliphatic polyester particles according to the present invention are PGA particles characterized in that the average particle diameter (50% D) thereof is 5 to 500 μm, and the fracture stress of a columnar tablet obtained by molding the particles in a cylindrical mold by applying a load of 4 kgf/cm² for 1 hour at a temperature of 40° C. is at most 500 gf/cm².

The raw material for producing the PGA particles according to the present invention may contain, in addition to the PGA, another resin such as another aliphatic polyester, a polyglycol such as polyethylene glycol or polypropylene glycol, modified polyvinyl alcohol, polyurethane or a polyamide such as poly-L-lysine and additives which are generally incorporated, such as a plasticizer, an antioxidant, a light stabilizer, a heat stabilizer, an ultraviolet light absorber, a lubricant, a parting agent, a wax, a colorant, a crystallization accelerator, a hydrogen ion concentration modifier, an end-capping agent and a filler such as reinforcing fiber within limits not impeding the object of the present invention as needed.

### [Weight Average Molecular Weight (Mw)]

The weight average molecular weight (Mw) of the PGA contained in the PGA particles according to the present invention is preferably within a range of 50,000 to 1,500,000, and PGA having a weight average molecular weight within a range of more preferably 60,000 to 1,300,000, still more preferably 70,000 to 1,100,000, particularly preferably 100,000 to 1,000,000 is selected. The weight average molecular weight (Mw) of the PGA is a value determined by means of a gel permeation chromatography (GPC) analyzer. In addition, the weight average molecular weight (Mw) of the PLA contained in the PLA particles according to the present invention is within a range of preferably 50,000 to 1,200,000, more preferably 60,000 to 1,000,000, still more preferably 70,000 to 800,000.

### [Crystalline Melting Point (Tm)]

The crystalline melting point (Tm) of the PGA contained in the PGA particles according to the present invention is generally 197 to 245° C. and may be controlled by, for example, a weight average molecular weight (Mw), a molecular weight distribution, and the kind and content of a copolymerization component. The crystalline melting point (Tm) of the PGA is preferably 200 to 240° C., more preferably 205 to 235° C., particularly preferably 210 to 230° C. The crystalline melting point (Tm) of a PGA homopolymer is generally about 220° C. If the crystalline melting point (Tm) is too low, strength and heat resistance may be insufficient in some cases. If the crystalline melting point (Tm) is too high, the processing ability of the resulting PGA particles may be insufficient, and it may be impossible to satisfactorily control the forming of the PGA particles, and so the PGA particles may fail to have a particle diameter within a desired range. The crystalline melting point (Tm) of the PGA is a value determined under a nitrogen atmosphere by means of a differential scanning calorimeter (DSC). Specifically, the crystalline melting point means a temperature of an endothermic peak attending on melting of a crystal, which is detected in the course of heating a sample PGA from a temperature near room temperature to about 280° C. [corresponding to a temperature near (the crystalline melting point (Tm)+50° C.)] at a heating rate of 20° C./min under a nitrogen atmosphere. When a plurality of endothermic peaks is observed, a temperature of a peak having the largest peak area is regarded as a crystalline melting point (Tm).

The crystalline melting point (Tm) of the PLA contained in the PLA particles according to the present invention is preferably 145 to 185° C., more preferably 150 to 182° C., still more preferably 155 to 180° C.

### [Glass Transition Temperature (Tg)]

The glass transition temperature (Tg) of the PGA contained in the PGA particles according to the present invention is generally 25 to 60° C., preferably 30 to 50° C., more preferably 35 to 45° C. The glass transition temperature (Tg) of the PGA may be controlled by, for example, a weight average molecular weight (Mw), a molecular weight distribution, and the kind and content of a copolymerization component. The glass transition temperature (Tg) of the PGA is a value determined under the nitrogen atmosphere by means of the differential scanning calorimeter (DSC) like the measurement of the crystalline melting point (Tm). Specifically, an intermediate point between a start temperature and an end temperature in secondary transition of the quantity of heat in a secondary transition region corresponding to a transition region from a glassy state to a rubbery state when a non-crystalline sample obtained by heating a PGA sample to about 280° C. [near (the crystalline melting point (Tm)+50° C.)], holding the sample for 2 minutes at this temperature and then quickly (at a rate of about 100° C./min) cooling the sample with liquid nitrogen is reheated from a temperature near room temperature to a temperature near 100° C. at a heating rate of 20° C./min under the nitrogen atmosphere by means of the DSC is regarded as a glass transition temperature (Tg) (hereinafter may referred to as “intermediate-point glass transition temperature”). If the glass transition temperature (Tg) is too low, the surfaces of the resulting PGA particles are excessively softened by a heat treatment which will be described subsequently, and so the particles may tend to undergo blocking in some cases. If the glass transition temperature (Tg) is too high, the resulting PGA particles are hard to cause property change of their surfaces even by the heat treatment which will be described subsequently, and so the blocking preventing effect on the particles may not be sufficiently improved in some cases.

In addition, the glass transition temperature (Tg) of the PLA is within a range of preferably 45 to 75° C., preferably 50 to 70° C., more preferably 55 to 65° C.

### [Average Particle Diameter (50% D)]

The average particle diameter (50% D) of the biodegradable aliphatic polyester particles such as the PGA particles according to the present invention is 5 to 500 μm. The average particle diameter (50% D) of the biodegradable aliphatic polyester particles means a value represented by a particle diameter that a cumulative weight from the side of the smallest particle diameter becomes 50% by means of a particle diameter distribution of the particles determined by using a laser diffraction type particle size distribution meter.

The average particle diameter (50% D) of the biodegradable aliphatic polyester particles according to the present invention is within a range of preferably 7 to 450 μm, more preferably 10 to 400 μm, still more preferably 20 to 300 μm, particularly preferably 30 to 200 μm. If the average particle diameter (50% D) is too small, the handleability and storage stability of such particles become poor. If the average particle diameter (50% D) is too large, it is difficult to use such particles in the intended uses. For example, when the average particle diameter is too large, the dispersion property of such particles in water becomes poor, and so it is difficult to use them in fields of paints, coating materials and toners. The average particle diameter (50% D) falls within the range of 5 to 500 μm, whereby the flow property of the biodegradable aliphatic polyester particles becomes good, the handleability and storage stability of the particles are good, and particles having a desired particle diameter required upon molding or forming into a product or use of the biodegradable aliphatic polyester particles such as the PGA particles can be extremely easily obtained.

### [Quantity (ΔHm) of Heat of Crystal Melting]

In the PGA particles according to the present invention, the quantity (ΔHm) of heat of crystal melting thereof is generally at least 50 J/g, preferably at least 60 J/g, more preferably at least 70 J/g. No particular limitation is imposed on the upper limit of the quantity (ΔHm) of heat of crystal melting. However, the upper limit thereof is generally about 100 J/g because when the crystallinity of the whole of the PGA particles becomes excessively high, the degradability excepted of the resulting product may be lowered in some cases. The quantity (ΔHm) of heat of crystalline melting of the PGA particles is determined under a nitrogen atmosphere by means of a differential scanning calorimeter (DSC) like the measurement of the crystal melting point (Tm). Specifically, the quantity of heat is calculated out by integrating areas of all endothermic peaks detected within a range of [the crystalline melting point (Tm)±40° C], which is detected in the course of heating a sample PGA from a temperature near room temperature to a temperature near [the crystalline melting point (Tm)+50° C.] at a heating rate of 20° C./min under the nitrogen atmosphere.

If the quantity (ΔHm) of heat of crystal melting of the PGA particles is less than 50 J/g, the crystallinity of the surfaces of such particles is low, and the PGA particles tend to undergo blocking and may be poor in handleability in some cases. The PGA particles according to the present invention are characterized in that the crystallinity in the vicinity of the particle surface is raised by, for example, the heat treatment which will be described subsequently, whereby the blocking preventing effect on the PGA particles is realized. Accordingly, there is no need to raise the crystallinity in the interior of the particle.

Incidentally, in the PLA particles according to the present invention, the quantity (ΔHm) of heat of crystal melting is generally at least 40 J/g, preferably at least 45 J/g, and the upper limit thereof may be about 70 J/g.

[Crystallization Temperature (T_{c1}) upon heating]

The crystallization temperature (T_{c1}) upon heating of the PGA particles according to the present invention is generally 75 to 120° C., preferably 80 to 115° C., more preferably 85 to 110° C., particularly preferably 88 to 105° C. The crystallization temperature (T_{c1}) upon heating of the PGA particles is determined under a nitrogen atmosphere by means of the DSC like the measurement of the crystal melting point (Tm). Specifically, the crystallization temperature means a temperature of an exothermic peak attending on crystallization, which is detected in the course of reheating a non-crystalline sample obtained by heating a PGA sample to about 280° C. [near (the crystalline melting point (Tm)+50° C.)], holding the sample for 2 minutes at this temperature and then quickly (at a rate of about 100° C./min) cooling the sample with liquid nitrogen from a temperature near room temperature to a temperature near [the crystalline melting point (Tm)+50° C.] at a heating rate of 20° C./min under the nitrogen atmosphere by means of the DSC. If the crystallization temperature (T_{c1}) upon heating is too low, the surfaces of such PGA particles are excessively softened by the heat treatment which will be described subsequently, and so the particles may tend to undergo blocking in some cases. If the crystallization temperature (T_{c1}) upon heating is too high, such PGA particles are hard to cause property change of their surfaces even by the heat treatment which will be described subsequently, and so the blocking preventing effect on the particles may not be sufficiently improved in some cases. The control of the crystallization temperature (T_{c1}) upon heating can be made by, for example, suitably selecting a polymerization degree (weight average molecular weight (Mw)), a molecular weight distribution, a molecular weight of PGA, and the kind and content of a polymerization component.

On the other hand, the crystallization temperature (T_{c1}) upon heating of the PLA particles according to the present invention is generally 80 to 140° C., preferably 85 to 135° C., more preferably 90 to 130° C., particularly preferably 95 to 125° C.

### [Fracture Stress of Tablet]

In the biodegradable aliphatic polyester particles according to the present invention, the fracture stress of a tablet of the particles, that is, the fracture stress of a columnar tablet obtained by molding the particles in a cylindrical mold by applying a load of 4 kgf/cm² for 1 hour at a temperature of 40° C. is at most 500 gf/cm². The fracture stress of the tablet of the particles is a value (average value of N=3) determined as a load (maximum load) at the time the tablet has been crushed and fractured by using a Kiya type hardness meter (manufactured by Fujiwara Scientific Company Co., Ltd.) and compressing the columnar tablet prepared under the predetermined conditions by applying a load in a vertical direction.

The columnar tablet used for the measurement of the fracture stress of the tablet of the biodegradable aliphatic polyester particles is a columnar tablet obtained by molding the particles in a cylindrical mold by applying a load of 4 kgf/cm² for 1 hour at a temperature of 40° C. Specifically, the tablet is a columnar tablet having an upper area of 1 cm², a lower area of 1 cm² and a height of 1.5 cm and prepared by filling 1 g of the biodegradable aliphatic polyester particles into a stainless-made cylindrical mold (inner diameter: 11.3 mm (inner sectional area: 1 cm²)), inserting a columnar weight (outer diameter: 11.3 mm, weight: 4 kg) from above the particles to apply a fixed load (4 kgf/cm²) to the particles, and leaving the mold at rest for 1 hour in a thermostat (relative humidity: about 10 to 30%) set to a predetermined temperature (40° C.) while applying the load in this state, thereby molding the particles.

In the biodegradable aliphatic polyester particles according to the present invention, the fracture stress of the columnar tablet obtained by molding the particles in the cylindrical mold by applying the load of 4 kgf/cm² for 1 hour at the temperature of 40° C. is at most 500 gf/cm², whereby the biodegradable aliphatic polyester particles are hard to undergo blocking even in summertime or upon storage or shipping of the particles in a container at which the particles may be exposed to a high temperature in some cases. In addition, even when the particles undergo blocking once, the blocking state of the particles can be extremely easily solved. On the other hand, in such biodegradable aliphatic polyester particles that the fracture stress of a columnar tablet obtained by molding the particles at a temperature of 40° C. exceeds 500 gf/cm², it is difficult to solve the blocking state of the biodegradable aliphatic polyester particles which have undergone the blocking, and so biodegradable aliphatic polyester particles having a particle diameter required for use application cannot be easily obtained. The fracture stress of the columnar tablet is preferably at most 400 gf/cm², more preferably at most 300 gf/cm²′ still more preferably at most 200 gf/cm², particularly preferably at most 100 gf/cm², most preferably at most 25 gf/cm² that is a limit of detection in the Kiya type hardness meter.

Further, in the biodegradable aliphatic polyester particles according to the present invention, the fracture stress of a columnar tablet obtained by molding the particles with the molding temperature for preparing the columnar tablet changed from 40° C. to a temperature of [the glass transition temperature (Tg) of the biodegradable aliphatic polyester+10° C.] is at most 2,000 gf/cm², whereby PGA particles far excellent in the blocking preventing effect can be provided. The fracture stress of the columnar tablet molded at the temperature of [the glass transition temperature (Tg)+10° C.] is preferably at most 1,900 gf/cm², more preferably at most 1,800 gf/cm², particularly preferably at most 1,700 gf/cm².

3. Production process of biodegradable aliphatic polyester particles

No particular limitation is imposed on the production process of the biodegradable aliphatic polyester particles according to the present invention so far as the average particle diameter (50% D) of the resulting particles is 5 to 500 μm, and the fracture stress of a tablet obtained by molding the particles in a cylindrical mold by applying a load of 4 kgf/cm² for 1 hour at a temperature of 40° C. is at most 500 gf/cm². However, the particles are preferably produced as a heat-treated product (hereinafter may referred to as “heat-treated product of the particles”) of the biodegradable aliphatic polyester particles by conducting a heat treatment in which a particulate biodegradable aliphatic polyester is treated at a temperature not lower than [the crystallization temperature (T_{c1}) upon heating−40° C]. Incidentally, the particulate biodegradable aliphatic polyester before the heat treatment is conducted may be referred to as “raw resin particles”. It is presumed that the crystallinity of the particle surface of the particulate biodegradable aliphatic polyester is raised by the above-described heat treatment, whereby the blocking preventing effect on the resulting biodegradable aliphatic polyester particles is realized. The “heat-treated product of the particles” may also be mixed with the “raw resin particles” before use so far as the blocking preventing effect is realized. A mass ratio of the “heat-treated product of the particles”! the “raw resin particles” is preferably at least 50/50, more preferably at least 70/30, most preferably 90/10.

### (1) Particulate Biodegradable Aliphatic Polyester

The biodegradable aliphatic polyester particles according to the present invention can be easily produced by treating a particulate biodegradable aliphatic polyester at the predetermined temperature described above. The raw resin particles such as the particulate PGA are those scheduled to be used as a molding material of a product or in the form of a dispersion liquid of the particles. Such particles are those pre-prepared so as to have predetermined average particle diameter, particle diameter distribution and particle shape, and no particular limitation is imposed on the production process thereof. The particles may also be those obtained by preferably washing a biodegradable aliphatic polyester such as PGA, which has been collected in the form of powder, flake or the like after a polymerization reaction and classifying it. The particles may also be those obtained by applying mechanical impact to the biodegradable aliphatic polyester collected to grind (impact-grind) it or freeze-grind it in particular. At that time, the resultant particles may also be classified as needed. Further, the particles may also be those obtained by impact-grinding pellets obtained by suitably incorporating compounding additives into the biodegradable aliphatic polyester such as PGA as needed and conducting melt extrusion. Furthermore, the particles may also be those obtained by providing the biodegradable aliphatic polyester such as PGA in the form of a solution or dispersion liquid in an organic solvent and then solidifying or depositing it. Since the blocking preventing effect is marked by providing the biodegradable aliphatic polyester particles such as PGA particles according to the present invention, the heat treatment, which will be described subsequently, is preferably conducted for the particles obtained by the impact-grinding, or the particulate biodegradable aliphatic polyester obtained by the impact-grinding method at a temperature lower than the glass transition temperature (Tg) of the biodegradable aliphatic polyester in particular.

The temperature of the impact-grinding which is conducted for producing the raw resin particles is preferably a temperature lower than the glass transition temperature (Tg) of the biodegradable aliphatic polyester, more preferably from −50° C. or higher to [the glass transition temperature (Tg)−5° C.] or lower, still more preferably from −45° C. or higher to [the glass transition temperature (Tg)−10° C.] or lower, particularly preferably from −40° C. or higher to [the glass transition temperature (Tg)−20° C.] or lower, most preferably from −35° C. or higher to [the glass transition temperature (Tg)−30° C.] or lower, and, specifically, a temperature range of from −45° C. to 30° C., more preferably from −40° C. to 20° C., most preferably from −35° C. to 10° C. may be selected. The particles of the biodegradable aliphatic polyester such as PGA are ground at a temperature within this temperature range, whereby the resin particles are ground in a state of low-temperature embrittlement, so that generation of heat upon the grinding can be inhibited to finely grind the particles without causing thermal property change. The particles after the grinding are preferably classified so as to have a size within the predetermined range as described above. As a device for conducting the low-temperature grinding, is preferred a device equipped with a refrigerating section with an ultra-low-temperature refrigerant such as liquid nitrogen and a grinding section and preferably combined with a particle size adjusting section, and a jet mill, a blade mill, a pin mill or the like may be used. However, the pin mill that grinding is conducted by a body-side disc pin which rotates at high speed and a stationary door-side disc pin is preferably used. The time for which the grinding is conducted by the impact-grinding method varies according to the treatment temperature at which impact-grinding is conducted. However, it is only necessary to set the time within a range of generally from 10 seconds to 20 minutes, preferably from 30 seconds to 15 minutes, more preferably from 1 minute to 10 minutes, particularly preferably from 90 seconds to 5 minutes.

### (2) Heat Treatment (Treatment Temperature and Treatment Time)

The biodegradable aliphatic polyester particles such as the PGA particles according to the present invention can be produced by treating the above-described particulate biodegradable aliphatic polyester, that is, the raw resin particles at a temperature not lower than [the crystallization temperature (T_{cl}) upon heating of the resin −40° C]. However, the raw resin particles must not be melted by the heat treatment. The treatment temperature is within a range of preferably from [the crystallization temperature (T_{c1}) upon heating−40° C.] or higher to [the crystalline melting point (Tm)−30° C.] or lower, more preferably from [the crystallization temperature (T_{cl}) upon heating−38° C.] or higher to [the crystalline melting point (Tm)−35° C.] or lower, still more preferably from [the crystallization temperature (T_{c1}) upon heating−36° C.] or higher to [the crystalline melting point (Tm)−40° C.] or lower, particularly preferably from [the crystallization temperature (T_{c1}) upon heating−34° C.] or higher to [the crystalline melting point (Tm)−45° C.] or lower. If the treatment temperature is too low, the surface profile of the PGA particles or the like is not sufficiently improved, and so there is a possibility that the blocking preventing effect may not be achieved. If the treatment temperature is too high, the surfaces of the PGA particles or the like may be softened or melted to result in aggregation in some cases. The treatment time varies according to the treatment temperature. However, it is only necessary to set the time within a range of generally from 1 minute to 10 hours, preferably from 2 minutes to 5 hours, more preferably from 3 minute to 180 minutes, particularly preferably from 4 minutes to 120 minutes. No particular limitation is imposed on a device for conducting the treatment so far as no excessive shearing force is exerted on the particles, and predetermined thermal energy can be applied to the PGA particles or the like, and an ordinary stirrer, mixer or kneader may be used. For example, a Henschel mixer or ribbon mixer may be used.

### EXAMPLES

The present invention will hereinafter be described more specifically by the following Examples and Comparative Examples. However, the present invention is not limited to these Examples.

Measuring methods of physical properties and characteristics or properties of biodegradable aliphatic polyester particles in Examples and Comparative Examples are as follows.

### [Weight Average Molecular Weight (Mw)]

The weight average molecular weight (Mw) was determined by dissolving 10 mg of sample particles of biodegradable aliphatic polyester particles in a solution with sodium trifluoroacetate dissolved at a concentration of 5 mM in hexafluoroisopropanol (HFIP) to prepare 10 ml of a solution, filtering the solution through a membrane filter to prepare a sample solution, and injecting 10 μl of this sample solution into a gel permeation chromatography (GPC) analyzer to measure a molecular weight under the following conditions.

### <Conditions for Measurement by GPC>

Apparatus: GPC104 manufactured by Showa Denko K.K.,
Column: HFIP-806M manufactured by Showa Denko K.K., two columns (connected in series)+precolumn: HFIP-LG, one column,
Column temperature: 40° C.,
Eluent: HFIP solution with sodium trifluoroacetate dissolved at a concentration of 5 mM,
Detector: Differential refractive index detector, and
Molecular weight calibration: The data of a calibration curve for molecular weight, which was prepared by using 5 kinds of polymethyl methacrylates (products of Polymer Laboratories Ltd.) having respective standard molecular weights different from one another, was used.

### [Crystalline Melting Point (Tm)]

A crystalline melting point (Tm) was determined from an endothermic peak which appeared when 10 mg of sample particles were heated from a temperature near room temperature to a temperature (about 280° C. when the sample was PGA, or about 220° C. when the sample was PLA) near [the crystalline melting point (Tm)+50° C.] at a heating rate of 20° C./min under a nitrogen atmosphere by means of a differential scanning calorimeter (DSC; TC-15 manufactured by Mettler Toledo International Inc.). When a plurality of crystalline melting points (Tm) was observed, a temperature of a peak having the largest peak area was regarded as a crystalline melting point (Tm).

[Glass transition Temperature (Tg)]

An intermediate-point glass transition temperature corresponding to a transition region from a glassy state to a rubbery state when a non-crystalline sample obtained by heating 10 mg of sample particles to about 280° C. when the sample was PGA or about 220° C. when the sample was PLA by means of a differential scanning calorimeter (DSC; TC-15 manufactured by Mettler Toledo International Inc.), holding the sample for 2 minutes at this temperature and then quickly (at a rate of about 100° C./min) cooling the sample with liquid nitrogen was reheated from a temperature near room temperature to a temperature near 100° C. at a heating rate of 20° C./min under a nitrogen atmosphere was regarded as a glass transition temperature (Tg).

[Crystallization Temperature (T_{c1}) upon Heating]

A crystallization temperature (T_{c1}) upon heating was determined from an exothermic peak which appeared when a non-crystalline sample obtained by heating 10 mg of sample particles to about 280° C. when the sample was PGA or about 220° C. when the sample was PLA by means of a differential scanning calorimeter (DSC; TC-15 manufactured by Mettler Toledo International Inc.), holding the sample for 2 minutes at this temperature and then quickly (at a rate of about 100° C./min) cooling the sample with liquid nitrogen was reheated from a temperature near room temperature to a temperature near [the crystalline melting point (Tm)+50° C.] at a heating rate of 20° C./min under a nitrogen atmosphere.

### [Quantity (ΔHm) of Heat of Crystal Melting]

A quantity (ΔHm) of heat of crystal melting was calculated out from all endothermic peaks detected within a range of [the crystalline melting point (Tm)±40° C.] when 10 mg of sample particles were heated from a temperature near room temperature to a temperature near [the crystalline melting point (Tm)+50° C.] at a heating rate of 20° C./min under a nitrogen atmosphere by means of a differential scanning calorimeter (DSC; TC-15 manufactured by Mettler Toledo International Inc.).

### [Average Particle Diameter (50% D)]

An average particle diameter of sample particles was determined by regarding a particle diameter that a cumulative weight from the side of the smallest particle diameter becomes 50% from a particle diameter distribution as to a particle dispersion liquid obtained by dispersing the sample particles in ion-exchanged water, which was determined by means of a laser diffraction type particle size distribution meter (SALADA-3000S, manufactured by Shimadzu Corporation), as an average particle diameter (50% D).

### [Fracture Stress of Tablet]

The fracture stress of a tablet of sample particles was determined as a maximum load (average value of N=3) required to fracture a columnar tablet prepared when the tablet was compressed in a vertical direction by means of a Kiya type hardness meter (manufactured by Fujiwara Scientific Company Co., Ltd.).

The columnar tablet was prepared by filling 1 g of the sample particles into a stainless-made cylindrical mold (inner diameter: 11.3 mm (inner sectional area: 1 cm²)), inserting a columnar weight (outer diameter: 11.3 mm, weight: 4 kg) from above the particles to apply a fixed load (4 kgf/cm²) to the particles, and leaving the mold at rest for 1 hour in a thermostat (relative humidity: 20%) set to a predetermined temperature [40° C. or (the glass transition temperature (Tg)+10° C.)] while applying the load in this state, thereby molding the particles into a columnar tablet having an upper area of 1 cm², a lower area of 1 cm² and a height of 1.5 cm.

### [Blocking Resistance]

The blocking resistance of sample particles was determined by the following method. About 15 g of the sample particles were precisely weighed and enclosed into a zippered polyethylene bag having a length under a zipper of 70 mm, a bag width of 50 mm and a thickness of 0.04 mm, the bag was stored for 1 day in a thermostat controlled to 40° C. while applying a load to the sample particles by a weight of 4 kg, the sample particles were then taken out of the bag and placed on a sieve having a sieve opening of 850 μm, and the sieve was shaken for 1 minute by hand to evaluate the sample particles as to the blocking resistance according to the following standard.

A: Sample left on the sieve is less than 20% by mass;
B: Sample left on the sieve is 20% by mass or more and 70% by mass or less;
C: Sample left on the sieve exceeds 70% by mass.

### Example 1

After about 20 kg of PGA (product of Kureha Corporation, Mw: 170,000, Tg: 40° C., _{Ti:} 98° C., Tm: 220° C., ΔHm: 70 J/g) was immersed in liquid nitrogen and refrigerated, the PGA was ground for 2 minutes under conditions of a grinding temperature of −25° C. and a peripheral speed of 187 msec by means of a pin mill (ultrafine powder pin mill: CONTRAPLEX SERIES; manufactured by Makino Mfg. Co., Ltd.) capable of refrigerating with liquid nitrogen upon grinding while refrigerating with liquid nitrogen, thereby obtaining particulate PGA. About 3 kg of the particulate PGA thus obtained was subjected to a stirring treatment for 5 minutes under conditions that a stirrer speed (number of revolutions) was 900 rpm, and a particle temperature during stirring was 60° C. by means of a stirrer (MITUI HENCHEL FM10B/L, manufactured by Mitsui Kozan Kabushiki Kaisha) to conduct a heat treatment, thereby obtaining PGA particles. The average particle diameter (50% D, hereinafter referred to as “particle diameter” merely), quantity (ΔHm) of heat of crystal melting and tablet fracture stress (products molded at 40° C. and 50° C.) of the resultant particles, and a test result of blocking resistance are shown in Table 1.

### Example 2

PGA particles were obtained in the same manner as in Example 1 except that the particle temperature during the stirring in the stirrer was changed to 80° C. The particle diameter, quantity of heat of crystal melting and tablet fracture stress of the resultant particles, and a test result of blocking resistance are shown in Table 1.

### Example 3

PGA particles were obtained in the same manner as in Example 1 except that the particle temperature during the stirring in the stirrer was changed to 120° C. The particle diameter, quantity of heat of crystal melting and tablet fracture stress of the resultant particles, and a test result of blocking resistance are shown in Table 1.

### Example 4

PGA particles were obtained in the same manner as in Example 3 except that the stirring time in the stirrer was changed to 60 minutes. The particle diameter, quantity of heat of crystal melting and tablet fracture stress of the resultant particles, and a test result of blocking resistance are shown in Table 1.

### Example 5

PGA particles were obtained in the same manner as in Example 1 except that the particle temperature during the stirring in the stirrer was changed to 160° C. The particle diameter, quantity of heat of crystal melting and tablet fracture stress of the resultant particles, and a test result of blocking resistance are shown in Table 1.

### Example 6

PGA particles were obtained in the same manner as in Example 2 except that the temperature upon the impact-grinding was changed to 5° C. The particle diameter, quantity of heat of crystal melting and tablet fracture stress of the resultant particles, and a test result of blocking resistance are shown in Table 1.

### Example 7

PGA particles were obtained in the same manner as in Example 6 except that the particle temperature during the stirring in the stirrer was changed to 120° C. The particle diameter, quantity of heat of crystal melting and tablet fracture stress of the resultant particles, and a test result of blocking resistance are shown in Table 1.

### Comparative Example 1

The particle diameter, quantity of heat of crystal melting and tablet fracture stress of the particulate PGA (in which the heat treatment using the stirrer was not performed) obtained by conducting the impact-grinding in Example 1, and a test result of blocking resistance are shown in Table 1.

### Comparative Example 2

PGA particles were obtained in the same manner as in Example 1 except that the particle temperature during the stirring in the stirrer was changed to 40° C. The particle diameter, quantity of heat of crystal melting and tablet fracture stress of the resultant particles, and a test result of blocking resistance are shown in Table 1.

### Comparative Example 3

PGA particles were obtained in the same manner as in Example 1 except that the particle temperature during the stirring in the stirrer was changed to 200° C. The particle diameter, quantity of heat of crystal melting and tablet fracture stress of the resultant particles, and a test result of blocking resistance are shown in Table 1.

### Comparative Example 4

The particle diameter, quantity of heat of crystal melting and tablet fracture stress of a particulate PGA prepared in the same manner as in Comparative Example 1 except that the grinding temperature was changed to 5° C., and a test result of blocking resistance are shown in Table 1.

TABLE 1

| | | | Heat treatment conditions | | Physical properties of particles | | | | |
|---|---|---|---|---|---|---|---|---|---|
| | | | Treatment | Treatment | | | Tablet fracture stress (gf/cm²) | | |
| | Raw | Grinding conditions | temperature | time | 50% D | ΔHm | Product molded | Product molded | Blocking |
| | material | Grinding temperature | (° C.) | (min) | (μm) | (J/g) | at 40° C. | at 50° C. | resistance |
| Ex. 1 | PGA | −25 | 60 | 5 | 150 | 72 | 100 | 150 | A |
| Ex. 2 | PGA | −25 | 80 | 5 | 150 | 74 | 25 or less | 25 or less | A |
| Ex. 3 | PGA | −25 | 120 | 5 | 150 | 74 | 25 or less | 25 or less | A |
| Ex. 4 | PGA | −25 | 120 | 60 | 150 | 74 | 25 or less | 25 or less | A |
| Ex. 5 | PGA | −25 | 160 | 5 | 150 | 75 | 25 or less | 25 or less | A |
| Ex. 6 | PGA | 5 | 80 | 5 | 150 | 73 | 25 or less | 25 or less | A |
| Ex. 7 | PGA | 5 | 120 | 5 | 150 | 69 | 25 or less | 25 or less | A |
| Comp. | PGA | −25 | None | None | 150 | 69 | 9100 | 8900 | C |
| Ex. 1 | | | | | | | | | |
| Comp. | PGA | −25 | 40 | 5 | 150 | 70 | 5000 | 4900 | C |
| Ex. 2 | | | | | | | | | |
| Comp. | PGA | −25 | 200 | 5 | 150 | 75 | Particles aggregated by melting upon heat treatment | | |
| Ex. 3 | | | | | | | | | |
| Comp. | PGA | 5 | None | None | 150 | 69 | 9400 | 25 or less | C |
| Ex. 4 | | | | | | | | | |

From Table 1, it was understood that the PGA particles obtained by treating the particulate PGA at a temperature of 60 to 160° C. are such PGA particles that the particle diameter (50% d) thereof is 150 μm, and the tablet fracture stress of the columnar tablet obtained by molding the PGA particles at a temperature of 40° C. is 100 gf/cm² or 25 gf/cm² or less, or such PGA particles that the tablet fracture stress of the columnar tablet obtained by molding the PGA particles at 50° C. corresponding to [the glass transition temperature (Tg) of the PGA+10° C.] is 150 gf/cm² or 25 gf/cm² or less, and the PGA particles have these characteristics, whereby the particles has an effect that the particles do not undergo blocking, or the blocking can be extremely easily solved.

On the other hand, it is understood that in the PGA particles of Comparative Example 2, which were obtained by treating the PGA at a temperature outside the temperature range of [the crystallization temperature (T_{c1}) upon heating of the PGA−40° C.] or higher, and the particulate PGAs of Comparative Examples 1 and 4, in which the heat treatment for the raw resin particles was not conducted at all, the tablet fracture stress of the columnar tablet obtained by molding the particulate PGA at 40° C. or 50° C. is great, such particles undergo blocking, and the blocking cannot be easily solved. In addition, the PGA particles of Comparative Example 3 were those melted and aggregated.

### Example 8

PLA particles were obtained in the same manner as in Example 2 except that the biodegradable aliphatic polyester used was changed from the PGA to PLA (7000D, product of Nature Works LLC, Mw: 120,000, Tg: 60° C., T_{c1}: 118° C., Tm: 165° C., ΔHm: 35 J/g), and the stirring time in the stirrer was changed from 5 minutes to 60 minutes. The particle diameter, quantity of heat of crystal melting and tablet fracture stress (products molded at 40° C. and 70° C.) of the resultant particles, and a test result of blocking resistance are shown in Table 2.

### Example 9

PLA particles were obtained in the same manner as in Example 8 except that the particle temperature during the stirring in the stirrer was changed to 120° C. The particle diameter, quantity of heat of crystal melting and tablet fracture stress of the resultant particles, and a test result of blocking resistance are shown in Table 2.

### Comparative Example 5

The particle diameter, quantity of heat of crystal melting and tablet fracture stress of the particulate PLA (in which the heat treatment using the stirrer was not performed) before the heat treatment by the stirring treatment in the stirrer was conducted, and a test result of blocking resistance are shown in Table 2.

TABLE 2

| | | | Heat treatment conditions | | Physical properties of particles | | | | |
|---|---|---|---|---|---|---|---|---|---|
| | | | Treatment | Treatment | | | Tablet fracture stress (gf/cm²) | | |
| | Raw | Grinding conditions | temperature | time | 50% D | ΔHm | Product molded | Product molded | Blocking |
| | material | Grinding temperature | (° C.) | (min) | (μm) | (J/g) | at 40° C. | at 70° C. | resistance |
| Ex. 8 | PLA | −25 | 80 | 60 | 150 | 49 | 25 or less | 1600 | A |
| Ex. 9 | PLA | −25 | 120 | 60 | 150 | 49 | 200 | 1000 | A |
| Comp. | PLA | −25 | None | None | 150 | 49 | 1300 | 10500 | C |
| Ex. 5 | | | | | | | | | |

From the results shown in Table 2, it was understood that the PLA particles obtained by treating the particulate PLA at a temperature corresponding to the range of [the crystallization temperature (T_{c1}) upon heating of the PLA−40° C.] or higher are such PLA particles that the particle diameter (50% d) thereof is 150 μm, and the tablet fracture stress of the columnar tablet obtained by molding the PLA particles at a temperature of 40° C. is 200 gf/cm² or 25 gf/cm² or less, or such PLA particles that the tablet fracture stress of the columnar tablet obtained by molding the PLA particles at 70° C. corresponding to [the glass transition temperature (Tg) of the PLA+10° C.] is 1,600 gf/cm² or 1,000 gf/cm², and the PLA particles have these characteristics, whereby the particles has an effect that the particles do not undergo blocking, or the blocking can be extremely easily solved.

On the other hand, it is understood that in the particulate PLA of Comparative Example 5, in which the heat treatment in the stirrer was not conducted, the tablet fracture stress of the columnar tablet obtained by molding the particulate PLA at 40° C. or 70° C. is great, and consequently such particles undergo blocking, and the blocking cannot be easily solved.

### INDUSTRIAL APPLICABILITY

The biodegradable aliphatic polyester particles such as PLA or PGA particles according to the present invention are particles characterized in that the average particle diameter (50% D) thereof is 5 to 500 μm, and the fracture stress of a columnar tablet obtained by molding the particles in a cylindrical mold by applying a load of 4 kgf/cm² for 1 hour at a temperature of 40° C. is at most 500 gf/cm², whereby particles of a biodegradable aliphatic polyester such as PLA or PGA, which are hard to cause blocking even upon storage or shipping thereof, are provided, so that the present invention is high in industrial applicability.

In addition, the present invention provides the production process of the biodegradable aliphatic polyester particles, which is characterized by treating a particulate biodegradable aliphatic polyester at a temperature not lower than [the crystallization temperature (T_{c1}) upon heating−40° C], whereby a process for simply providing particles of a biodegradable aliphatic polyester such as PLA or PGA, which are hard to cause blocking even upon storage or shipping thereof, is provided, so that the present invention is high in industrial applicability.

1. Biodegradable aliphatic polyester particles having the following physical properties (A) and (B):
(A) the average particle diameter thereof is 5 to 500 μm; and
(B) the fracture stress of a columnar tablet obtained by molding the particles in a cylindrical mold by applying a load of 4 kgf/cm² for 1 hour at a temperature of 40° C. is at most 500 gf/cm².

2. The biodegradable aliphatic polyester particles according to claim 1, which further have the following physical property (C):
(C) the fracture stress of a columnar tablet obtained by molding the particles in a cylindrical mold by applying a load of 4 kgf/cm² for 1 hour at a temperature of (the glass transition temperature of a biodegradable aliphatic polyester contained in the biodegradable aliphatic polyester particles+10° C.) is at most 2,000 gf/cm².

3. The biodegradable aliphatic polyester particles according to claim 1, wherein the biodegradable aliphatic polyester is polyglycolic acid, polylactic acid or a mixture thereof.

4. The biodegradable aliphatic polyester particles according to claim 1, which are obtained by treating a particulate biodegradable aliphatic polyester at a temperature not lower than (the crystallization temperature upon heating of the biodegradable aliphatic polyester−40° C.).

5. The biodegradable aliphatic polyester particles according to claim 1, wherein the particulate biodegradable aliphatic polyester is obtained by grinding at a temperature lower than the glass transition temperature of the biodegradable aliphatic polyester.

6. A process for producing the biodegradable aliphatic polyester particles according to claim 1, which comprises treating a particulate biodegradable aliphatic polyester at a temperature not lower than (the crystallization temperature upon heating of the biodegradable aliphatic polyester−40° C.).

7. The production process of the biodegradable aliphatic polyester particles according to claim 6, wherein the particulate biodegradable aliphatic polyester is obtained by grinding at a temperature lower than the glass transition temperature of the biodegradable aliphatic polyester.

8. The biodegradable aliphatic polyester particles according to claim 2, wherein the biodegradable aliphatic polyester is polyglycolic acid, polylactic acid or a mixture thereof.

9. The biodegradable aliphatic polyester particles according to claim 2, which are obtained by treating a particulate biodegradable aliphatic polyester at a temperature not lower than (the crystallization temperature upon heating of the biodegradable aliphatic polyester−40° C.).

10. The biodegradable aliphatic polyester particles according to claim 2, wherein the particulate biodegradable aliphatic polyester is obtained by grinding at a temperature lower than the glass transition temperature of the biodegradable aliphatic polyester.

11. A process for producing the biodegradable aliphatic polyester particles according to claim 2, which comprises treating a particulate biodegradable aliphatic polyester at a temperature not lower than (the crystallization temperature upon heating of the biodegradable aliphatic polyester−40° C.).

12. The production process of the biodegradable aliphatic polyester particles according to claim 11, wherein the particulate biodegradable aliphatic polyester is obtained by grinding at a temperature lower than the glass transition temperature of the biodegradable aliphatic polyester.
